(19) United States
(12) Patent Application Publication
(10) Pub. No.: US 2023/0181412 A1
(43) Pub. Date: Jun. 15, 2023

(54) Scalp scratching apparatus

(71) Applicant: Joseph Eddy Jerome, Philadelphia, PA (US)

(72) Inventor: Joseph Eddy Jerome, Philadelphia, PA (US)

(21) Appl. No.: 17/300,898

(22) Filed: Dec. 13, 2021

(51) Int. Cl. A61H 7/00

(52) U.S. Cl. CPC A61H 7/003; A61H 2205/021; A61H 2201/0153; A61H 2201/1692

(57) ABSTRACT

The present invention relates to a scalp scratching apparatus comprising, an elongated body 100 constructed in wide and flat shape having 7.50 inches length divided in to a first section 101 for providing holding space to a user 108, a second section 102 attached with a first spherical surface 103 in order to scratch braided hair, a third section 104 attached with an arch 106 tilted at an angle of 20 degrees connected to a second spherical surface 105 in order to scratch back of the scalp.

### FIELD OF THE INVENTION

The present invention relates to a scalp scratching apparatus that alleviate the irritation or itching caused on scalp caused due to hair addition by providing a mechanism to effectively scratch scalp irrespective of location or density of hair.

### BACKGROUND OF THE INVENTION

Hairstyles are very essential part of beauty that enhances the looks of a person either male or female. But for the better hair style a thick amount of hair is required. In case of less amount of hair, many people take help of a hair dresser or health care professional for adding artificial hair or implanting the hair follicle over the bald areas. These hair addition processes although increase the density of hair over the areas having less amount of hair but at the same time leads to itching or burning sensation over scalp.

In order to alleviate the itching caused over the scalp various known hair care tools such as conventional hair combs have been used by a user to scratch the scalp. Upon scratching the teeth of comb over the affected part the blood circulation of the scalp increases resulting in decrease in the itching or irritation. These hair combs have fixed spacing between the teeth which is not suitable for hair density varying with different part of head as well as the massaging sensation produced by these conventional combs is also very low.

For overcoming the above problem, many hair massaging devices have been developed. These massaging devices apply vibrational effect over the scalp to reduce the irritability faced by the user. The application of these massagers over the front portion of the head is very easy but application of the massagers over back of the scalp is very tedious. Hence, these devices produce good reliving effect over the front part of the head but the efficacy of these devices over the back of the scalp is less as reaching to the back of the scalp is very tedious. Also, the use of these massaging devices just for the sake of alleviating the itching over the scalp leads to disarrangement of hair.

To overcome the above mentioned drawback, many hair scratchers have been used that helps user to scratch the scalp without disarrangement of hair. These hair scratchers have a pointed edge to scratch the scalp to alleviate the irritation caused on scalp. Although, these scratchers solve the problem of disarrangement of the hair, but the problem related to scratching of back of the scalp still persists.

Various hair brushes are available in market that is used to alleviate irritation over the scalp. These hair brushes include a hair brush, U.S. Pat. No. 9,326,591 granted to Alyssa Carolyn Nicoline that includes multiple portions that include a brush head associated with front face, a back face, and a central aperture extending through the brush head from the front face to the back face. The brush head has a length L ranging from about 0.2 L to about 0.9 L and a width ranging from about 0.2 W to about 0.9 W.

Adding to this, one more prior art U.S. Pat. No. 20,130,276,806 granted to Crystal Ann Haynes pertains to a scalp care device. The scalp care device has a handle that extends along a longitudinal axis and a set of curved teeth that also extend along the longitudinal axis. The teeth are curved to allow for sliding of the teeth beneath a user's hair, allowing the tips of the teeth to reach the user's scalp and manipulate it in order to care for it. A bridge connects the curved teeth to the handle. In one version, the teeth are hollow, and the handle has a bottle that holds liquid, allowing the liquid to flow through the teeth and be deposited on the scalp.

One more prior art U.S. Pat. No. 8,533,894 granted to Toshio Watanabe and Keiji Yoshii that belongs to a scalp washing device that includes a base with brush projections. Each one of the projections has a root part on one of the base's sides with a circular cross-section, a middle portion with a flattened cross-section tip surface, and at least a pair of conical tip projections on the tip surface, each with a tip chamfered to have a curved surface. From a side of the root part to a side of the tip surface, the cross-sectional form of the middle portion changes from a circular shape to a flattened shape.

Lots of hair scratchers are available in market which is used to scratch the scalp. These hair scratchers includes a head scratcher U.S. Pat. No. 3,768,463 granted to D. Curry refers to a tool for scratching and massaging the scalp, as well as combing and elevating depressed parts of bouffant and afro hair styles. A manual handle and an extended thin rigid prong adjustably fixed at one end in the handle and extending axially from it are included in the devices. On the prong's terminal end, a rounded scalp-engaging point is supplied. A detachable cover is included that is designed to fit over the extended prong and connect with the handle to enclose the prong when not in use.

Concluding all the above cited disclosures i.e. U.S. Pat. Nos. 9,326,591 20,130,276,806, 8,533,894 & 3,768,463 are focused on providing a device or an apparatus that enables the user to scratch the scalp in order to relieve the discomfort produced by hair growth on the scalp. However, none of the previous art allows a user to scratch the scalp depending on hair density without hurting the user's skin.

In order to increase the reliving effect pertaining to the scratching of the scalp, there exists a wide and essential requirement of a scalp scratching apparatus that helps user to scratch the scalp of the user irrespective of hair density and location without damaging the skin.

### OBJECTS OF THE INVENTION

The principal object of the present invention is to overcome the disadvantages of the prior art.

An object of the present invention is to provide an apparatus for alleviating the irritation or itching caused due to addition of hair potion having less density of hair.

An object of the present invention is to provide an apparatus for scratching the scalp of user irrespective of density of the hair.

Another object of the present invention is to provide an apparatus to scratch the scalp without damaging the skin of the head.

Yet another object of the present invention is to provide an apparatus that enables user to scratch back of the scalp conveniently.

The foregoing and other objects, features, and advantages of the present invention will become readily apparent upon further review of the following detailed description of the preferred embodiment as illustrated in the accompanying drawings.

### SUMMARY OF THE INVENTION

The present invention relates to a scalp scratching apparatus that alleviates the irritation and itching caused due to the addition of hair on less haired parts of the head by enabling user for scratching the scalp irrespective of hair density and location, without damaging the skin portion.

According to an aspect of the present invention, a scalp scratching apparatus, comprising an elongated body divided in at least three sections, a middle section constructed with a wide and flattened surface in order to allow user to hold the body, a lower section structured with a first spherical surface to scratch scalp beneath braided hair, an upper section fabricated with tilted arch connected to second spherical surface to scratch back of the scalp and a upper section carved with plurality of rounded shaped edges for scratching areas having low hair density without damaging skin of user.

While the invention has been described and shown with particular reference to the preferred embodiment, it will be apparent that variations might be possible that would fall within the scope of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a diagrammatic view of scalp scratching apparatus attached with first spherical surface;

FIG. 2 illustrates a diagrammatic view of proposed apparatus in association with first and second spherical surface;

FIG. 3 illustrates an enlarged view of second spherical surface and plurality of rounded shaped edges associated with present apparatus;

FIG. 4 illustrates a diagrammatic view of proposed apparatus showing application of the plurality rounded shaped edges over the scalp of user;

FIG. 5 illustrates a diagrammatic view of proposed apparatus showing application of the first spherical surface over the scalp of user; and

FIG. 6 illustrates a diagrammatic view of proposed apparatus showing application of the second spherical surface over the scalp of user.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” “consists essentially of,” and the like or the respective closed phrases “consisting of,” “consists of, the like.

As used herein, the singular forms “a,” “an,” and “the” designate both the singular and the plural, unless expressly stated to designate the singular only.

The present invention relates to a scalp scratching apparatus intended to alleviate the irritation or itching feel on the scalp of head due to addition of hair by providing a scratching point that is able to scratch the scalp irrespective of hair density or location. The present invention is designed in such a manner that it allows user to scratch the scalp without causing any damage over the scalp skin.

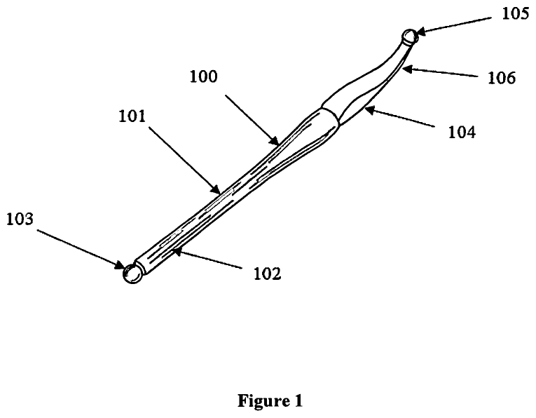

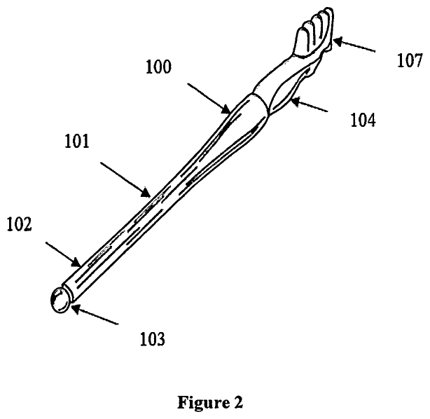

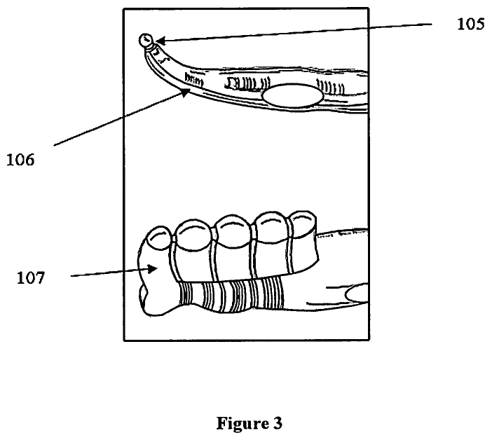

Turning now to the drawings in accordance with the embodiment of the present invention, FIG. 1 and FIG. 2 clearly depicts a diagrammatic view of a scalp scratching apparatus in connection with spherical surfaces and plurality of rounded shaped edges, comprising an elongated body 100 divided in at least three sections associated with the present apparatus, a first section 101 connected to the body 100, a second section 102 structured with first spherical surface 103 connected to lower part of the first section 101, a third section 104 carved with an arch 106 having a second spherical surface 105 connected to the upper part of the first section 101 as depicted in FIG. 3.

The apparatus includes an elongated body 100 divided in to at least three sections. The “elongated body 100” herein refers to a solid body having an ideal length of 7.50 inches. The elongated body 100 is further divided in to a first section 101 that resembles with middle portion, a second section 102 i.e. lower section and a third section 104 resembles with upper section. The first section 101 associated with the body 100 is constructed with a wide and flattened surface in order to provide proper gripping provision to user 108. The first section 101 has a wide flattened surface so that it may fit in to hands of user 108 easily to provide adequate proper control over the apparatus. The wide surfaced first section 101 helps the user 108 to grab the body 100 with larger contact area, wherein the larger contact area increases the gripping force between the first section 101 and the hand of user 108.

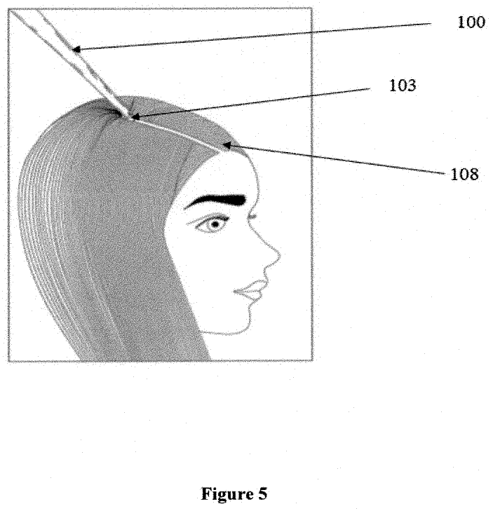

The first section 101 is further connected with a second section 102 from the downward side. The second section 102 is constructed with a first spherical surface 103 from the side which is not connected to the first section 101. The first spherical surface 103 resembles with a spherical ball having a diameter less than the width of the first section 101. This change in dimension of the end having first spherical surface 103 constructs a pointed shape, wherein the pointed end helps user 108 to scratch the scalp as depicted in FIG. 5, in case of tight hair weaved or braided area. Further the spherical point has less piercing effect that prevents any skin damage during scratching the scalp.

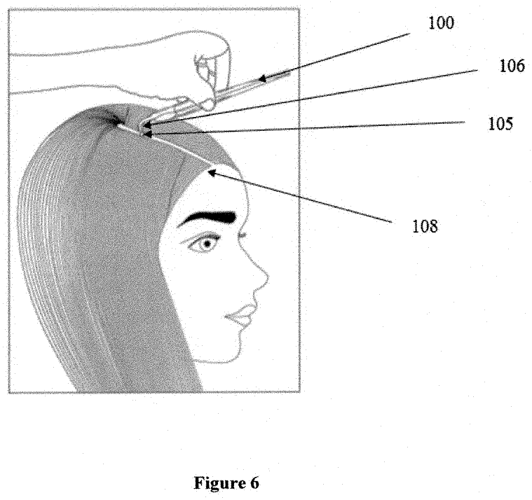

Further, the first section 101 from the top side is connected to a third section 104 having an arch 106 carved at an angle of 20 degrees and having a second spherical surface 105. The scalp of a human's head is not flat, rather that it is carved in a specific shape. Therefore the third section 104 is also preferably designed in a such a way that, to adapt the curved surface of the scalp as shown in FIG. 6, the third section 104 is attached with an arch 106 tilted with an angle of 20 degrees. This tilt given to the third section 104 increases the adaptability of the apparatus and allows user 108 to scratch the back of the scalp very easily.

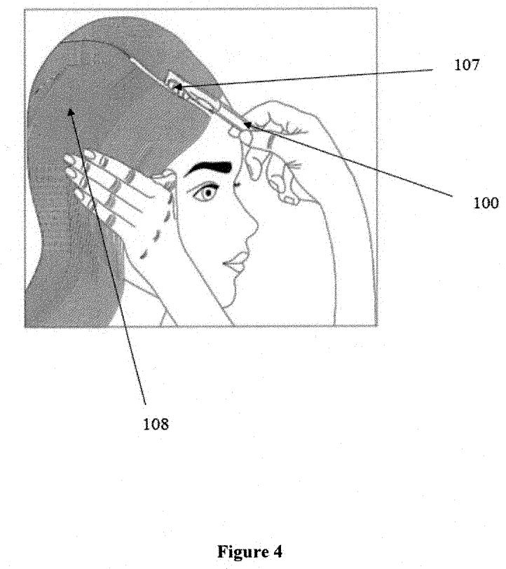

In an embodiment of the present invention, for low density hair, the third section 104 is constructed in such a manner that it includes plurality of rounded shape edges 107 for scratching the areas having low density of hair as illustrated in FIG. 4. The third section 104 is constructed with five numbers of rounded edges. The rounded edges 107 are designed with a uniform cross section starting from the base of the third section 104. If the user 108 scratches the scalp having less hair density with pin pointed edge, then it may damage the skin of the scalp. To solve the problem of skin damage due to scratching the third section 104 is provided with rounded second spherical surface 105 that exerts less pressure on the scalp, wherein this less pressure prevents the scalp from damaging.

Although the field of the invention has been described herein with limited reference to specific embodiments, this description is not meant to be construed in a limiting sense. Various modifications of the disclosed embodiments, as well as alternate embodiments of the invention, will become apparent to persons skilled in the art upon reference to the description of the invention.

We claim:

1) A scalp scratching apparatus, comprising:
an elongated body 100 divided into at least three sections 101, 102 and 104, categorized as a first 101, second 102 and third 104 sections, wherein a first section 101 constructed with a wide and flattened surface to allow a user 108 for handholding said body 100, a second section 102 structured with a first spherical surface 103 to allow said user 108 for gripping said body 100 in order to manoeuvre said body 100 with an ease and a third section 104 carved with an arch 106 inclined at a certain angle along with an attachment of a second spherical surface 105 in order to scratch scalp of said user 108 with high density of hair without damaging said user's skin.

2) The apparatus as claimed in claim 1, wherein for low density hairs, said third section 104 is structured in a different form such that said third section 104 is carved with plurality of rounded shaped edges 107 for scratching wide exposed scalp areas of said user 108 without damaging said user's skin.

3) The apparatus as claimed in claim 1, wherein length of said body 100 is ideally 7.50 inches.

4) The apparatus as claimed in claim 1, wherein said certain angle of arch 106 is ideally 20 degrees.
